(19) United States
(12) Patent Application Publication
(10) Pub. No.: US 2014/0309351 A1
(43) Pub. Date: Oct. 16, 2014

(54) BARRIER PROPERTIES OF HDPE FILM

(71) Applicant: NOVA CHEMICALS (INTERNATIONAL) S.A., Fribourg (CH)

(72) Inventors: Owen C. Lightbody, Calgary (CA); P. Scott Chisholm, Calgary (CA); Norman Dorien Joseph Aubee, Okotoks (CA); Tony Tikuisis, Calgary (CA)

(73) Assignee: NOVA CHEMICALS (INTERNATIONAL) S.A., Fribourg (CH)

(21) Appl. No.: 14/359,664

(22) PCT Filed: Nov. 2, 2012
(86) PCT No.: PCT/CA2012/001017

§ 371 Date: May 21, 2014

(30) Foreign Application Priority Data
Nov. 28, 2011 (CA) 2759953

(51) Int. Cl. C08K 5/098; C08J 5/18

(52) U.S. Cl. CPC C08K 5/098; C08J 5/18; C08J 2323/06
USPC 524/396

(57) ABSTRACT

A composition comprising high density polyethylene (HDPE), calcium phthalate and a metal stearate is provided. Film that is prepared from this composition has excellent barrier properties—especially a low water vapor transmission rate (WVTR)—and is suitable for the preparation of packaging for dry foods such as crackers and cereals.

### TECHNICAL FIELD

This invention relates to barrier films which are prepared from linear high density polyethylene (HDPE) and an additive package that includes calcium phthalate and zinc stearate. The films may be used to prepare packaging for dry foods such as crackers and breakfast cereals.

### BACKGROUND ART

Polyethylene may be classified into two broad families, namely “random” (which is commercially prepared by initiation with free radicals under polymerization conditions that are characterized by the use of very high ethylene pressures) and “linear” (which is commercially prepared with a transition metal catalyst, such as a “Ziegler Natta” catalyst, or a “chromium” catalyst, or a single site catalyst or a “metallocene catalyst”).

Most “random” polyethylene which is commercially sold is a homopolymer polyethylene. This type of polyethylene is also known as “high pressure low density polyethylene” because the random polymer structure produces a lower polymer density. In contrast, most “linear” polyethylene which is commercially sold is copolymer of ethylene with at least one alpha olefin (especially butene, hexene or octene). The incorporation of a comonomer into linear polyethylene reduces the density of the resulting copolymer. For example, a linear ethylene homopolymer generally has a very high density (typically greater than 0.955 grams per cubic centimeter (g/cc))—but the incorporation of small amounts of comonomer results in the production of so-called “high density polyethylene” (or “HDPE”—typically, having densities greater than 0.940 g/cc) and the incorporation of further comonomer produces so-called “linear low density polyethylene” (or “lldpe”—typically having a density of from about 0.905 g/cc to 0.940 g/cc).

Some plastic film is made from HDPE. One particular type of HDPE film is used to prepare food packaging with “barrier properties”—i.e. the film acts as a “barrier” to water vapor transmission. This so-called “barrier film” is used to prepare packages (or liners for cardboard packages) for breakfast cereals, crackers and other dry foodstuffs.

It has recently been discovered that the barrier properties of HDPE film may be improved by the addition of certain nucleating agents. However, for reasons that are not understood, other nucleating agents do not improve the barrier properties of HDPE films.

We have now discovered another additive package that provides enhanced barrier performance.

### DISCLOSURE OF INVENTION

In one embodiment, the present invention provides:
a polyethylene composition comprising:
   a) high density polyethylene;
   b) from 500 to 5000 parts per million by weight of calcium phthalate; and
   c) from 500 to 5000 parts per million by weight of at least one metal stearate selected from the group consisting of zinc stearate and calcium stearate.

In another embodiment, the present invention provides:
a process to improve the barrier performance of high density polyethylene film, said process comprising the film extrusion of a composition comprising
   a) a high density polyethylene having a melt index, 12, of from 0.2 to 20 grams per 10 minutes and a density of from 0.960 to 0.968 g/cc;
   b) from 500 to 5000 parts per million by weight of calcium phthalate; and
   c) from 500 to 5000 parts per million by weight of at least one metal stearate from the group consisting of zinc stearate and calcium stearate;
      wherein said film has at least a 15% improvement, compared with a film prepared in the absence of said calcium phthalate, in the water vapor barrier property.

### BEST MODE FOR CARRYING OUT THE INVENTION

### High Density Polyethylene (HDPE)

The polyethylene used in this invention is high density polyethylene (HDPE). As used herein, the term high density polyethylene means that the density is greater than 0.940 grams per cubic centimeter (g/cc) as measured by ASTM D1505.

The composition of this invention is suitable for preparing plastic film having enhanced barrier performance and it is also suitable for preparing molded goods (such as extruded profiles/pipes or injection molded parts such as caps or closures). It is preferred to use a HDPE having a melt index, I₂, of from 0.2 to 20 grams per 10 minutes and a density of from 0.960 to 0.968 g/cc when preparing film. I₂ is measured by ASTM D 1238, (when conducted at 190° C., using a 2.16 kg weight). Molded goods are preferably prepared from a HDPE having a density of from 0.940 g/cc to 0.970 g/cc and a melt index of from 0.2 to 200 grams per 10 minutes.

It is preferred that the HDPE resin does not contain “long chain branching.”

It is especially preferred to use blends of HDPE when preparing films having enhanced barrier properties. Highly preferred blends are described in more detail in the section entitled: HDPE Blends for Barrier Films.

### Barrier Film and Food Packaging

Plastic films are widely used as packaging materials for foods. Flexible films, including multilayer films, are used to prepare bags, wrappers, pouches and other thermoformed materials.

The permeability of these plastic films to gases (especially oxygen) and moisture is an important consideration during the design of a suitable food package.

Films prepared from thermoplastic ethylene-vinyl alcohol (“EVOH”) copolymers are commonly employed as an oxygen barrier and/or for resistance to oils. However, EVOH films are quite permeable to moisture.

Conversely, polyolefins, especially high density polyethylene, are resistant to moisture transmission but comparatively permeable to oxygen.

The permeability of linear polyethylene film to moisture is typically described by a “water vapor transmission rate” (or “WVTR”). In certain applications some vapor transmission is desirable—for example, to allow moisture out of a package which contains produce. The use of linear low density polyethylene (lldpe) which may be filled with calcium carbonate (to further increase vapor transmission) is common for this purpose.

Conversely, for packages which contain crispy foods such as breakfast cereals or crackers, it is desirable to limit WVTR to very low levels to prevent the food from going stale. The use of HDPE to prepare “barrier film” is common for this purpose. A review of plastic films and WVTR behavior is provided in U.S. Pat. No. 6,777,520 (McLeod et al.)

This invention relates to “barrier films” prepared from HDPE—i.e. films with low MVTR. As will be appreciated from the above description of EVOH films, it is also known to prepare multilayer barrier films to produce a structure which is resistant to moisture and oxygen. Multilayer structures may also contain additional layers to enhance packaging quality—for example, additional layers may be included to provide impact resistance or sealability. It will also be appreciated by those skilled in the art that “tie layers” may be used to improve the adhesion between “structural” layers. In such multilayer structures, the HDPE barrier layer may either be used as an internal (“core”) layer or external (“skin”) layer.

The manufacture of “barrier” food packaging from plastic resins involves two basic operations.

The first operation involves the manufacture of plastic film from the plastic resin. Most “barrier films” are prepared by “blown film” extrusion, in which the plastic is melted in an extruder, then forced through an annular die. The extrudate from the annular die is subjected to blown air, thus forming a plastic bubble. The use of multiple extruders and concentric dies permits multilayer structures to be co-extruded by the blown film process. The “product” from this operation is “barrier film” which is collected on rolls and shipped to the manufacturers of food packaging.

The manufacturer of the food packaging generally converts the rolls of blown film into packaged foods. This typically involves three basic steps:
1) forming the package;
2) filling the package;
3) sealing the food in the finished package.

Although the specific details will vary from manufacturer to manufacturer, it will be readily appreciated that the film needs to have a balance of physical properties in order to be suitable for food packaging. In addition to low MVTR, it is desirable for the film to “seal” well and to have sufficient impact strength and stiffness (or film “modulus”) to allow easy handling of the package. Multilayer coextrusions are often used to achieve this balance of properties, with 3 and 5 layer coextrusions being well known. Sealant layers may be prepared with ethylene—vinyl acetate (EVA) ionomers (such as those sold under the trademark SURLYN™ by E.I. DuPont), very low density polyethylene (polyethylene copolymers having a density of less than 0.910 grams per cubic centimeter) and blends with small amounts of polybutene. It is known to use sealant compositions in both “skin” layers of a coextrusion or in only one of the skin layers.

### HDPE Blends for Barrier Films

In an especially preferred embodiment, a blend of two HDPE resins is used for barrier films, as discussed below.

Blend Component a)

Blend component a) of a preferred polyethylene composition used in this invention comprises an HDPE with a comparatively high melt index. As used herein, the term “melt index” is meant to refer to the value obtained by ASTM D 1238 (when conducted at 190° C., using a 2.16 kg weight). This term is also referenced to herein as “I₂” (expressed in grams of polyethylene which flow during the 10 minute testing period, or “gram/10 minutes”). As will be recognized by those skilled in the art, melt index, I₂, is in general inversely proportional to molecular weight. Thus, blend component a) has a comparatively high melt index (or, alternatively stated, a comparatively low molecular weight) in comparison to blend component b).

The absolute value of I₂ for blend component a) is preferably greater than 5 grams/10 minutes. However, the “relative value” of I₂ for blend component a) is also important—it is preferably at least 10 times higher than the I₂ value for blend component b) [which I₂ value for blend component b) is referred to herein as I₂′]. Thus, for the purpose of illustration: if the I₂′ value of blend component b) is 1 gram/10 minutes, then the I₂ value of blend component a) should be at least 10 grams/10 minutes.

A preferred blend component a) is further characterized by:
i) density—it should have a density of from 0.950 to 0.975 g/cc; and
ii) weight % of the overall polyethylene composition—it should be present in an amount of from 5 to 60 weight % of the total HDPE composition (with blend component b) forming the balance of the total polyethylene) with amounts of from 10 to 40 weight %, especially from 20 to 40 weight %, being preferred. It is permissible to use more than one high density polyethylene to form blend component a).

The molecular weight distribution [which is determined by dividing the weight average molecular weight (Mw) by number average molecular weight (Mn) where Mw and Mn are determined by gel permeation chromatography, according to ASTM D 6474-99] of component a) is preferably from 2 to 20, especially from 2 to 4. While not wishing to be bound by theory, it is believed that a low Mw/Mn value (from 2 to 4) for component a) may improve the nucleation rate and overall barrier performance of blown films prepared according to the process of this invention.

Blend Component b)

Blend component b) is also a high density polyethylene which has a density of from 0.950 to 0.970 g/cc (preferably from 0.955 to 0.965 g/cc).

The melt index of blend component b) is also determined by ASTM D 1238 at 190° C. using a 2.16 kg load. The melt index value for blend component b) (referred to herein as I₂′) is lower than that of blend component a), indicating that blend component b) has a comparatively higher molecular weight. The absolute value of I₂′ is preferably from 0.1 to 2 grams/10 minutes.

The molecular weight distribution (Mw/Mn) of component b) is not critical to the success of this invention, though a Mw/Mn of from 2 to 4 is preferred for component b). As noted above, the ratio of the melt index of component b) divided by the melt index of component a) is preferably greater than 10/1.

Blend component b) may also contain more than one HDPE resin.

### Overall HDPE Blend Composition

The overall high density blend composition is formed by blending together blend component a) with blend component b). This overall HDPE composition preferably has a melt index (ASTM D 1238, measured at 190° C. with a 2.16 kg load) of from 0.5 to 10 grams/10 minutes (preferably from 0.8 to 8 grams/10 minutes).

The blends may be made by any blending process, such as: 1) physical blending of particulate resin; 2) co-feed of different HDPE resins to a common extruder; 3) melt mixing (in any conventional polymer mixing apparatus); 4) solution blending; or, 5) a polymerization process which employs 2 or more reactors.

One preferred HDPE blend composition is prepared by melt blending the following two blend components in an extruder:
from 10 to 30 weight % of component a): where component a) is a conventional HDPE resin having a melt index, I₂, of from 15-30 grams/10 minutes and a density of from 0.950 to 0.960 g/cc with
from 90 to 70 weight % of component b): where component b) is a conventional HDPE resin having a melt index, I₂, of from 0.8 to 2 grams/10 minutes and a density of from 0.955 to 0.965 g/cc.

An example of a commercially available HDPE resin which is suitable for component a) is sold under the trademark SCLAIR™ 79F, which is an HDPE resin that is prepared by the homopolymerization of ethylene with a conventional Ziegler Natta catalyst. It has a typical melt index of 18 grams/10 minutes and a typical density of 0.963 g/cc and a typical molecular weight distribution of about 2.7.

Examples of commercially available HDPE resins which are suitable for blend component b) include (with typical melt index and density values shown in brackets):

SCLAIR™ 19G (melt index=1.2 grams/10 minutes, density=0.962 g/cc);

MARFLEX™ 9659 (available from Chevron Phillips, melt index=1 grams/10 minutes, density=0.962 g/cc); and

ALATHON™ L 5885 (available from Equistar, melt index=0.9 grams/10 minutes, density=0.958 g/cc).

A highly preferred HDPE blend composition is prepared by a solution polymerization process using two reactors that operate under different polymerization conditions. This provides a uniform, in situ blend of the HDPE blend components. An example of this process is described in published U.S. patent application 20060047078 (Swabey et al.). The overall HDPE blend composition preferably has a MWD (Mw/Mn) of from 3 to 20.

### Calcium Phthalate

Calcium phthalate is a known molecule, with CAS registry number 5793-85-1. A literature search indicates that calcium phthalate is not in current use as a polyethylene additive.

However, the literature does show that calcium phthalate is known to act as a nucleating agent for polypropylene (Li et al., Journal of Applied Polymer Science, Vol 86, 633-638 (2002)).

The calcium phthalate used in the examples described below was prepared in a conventional manner by stirring calcium hydroxide (75 g) and phthalic anhydride (150 g) in 1500 ml of deionized water. The ingredients were stirred for 24 hours. The product precipitated from the water and was filtered, then dried at 135° C. for 20 hours. The product was characterized by Fourier Transform Infra Red (FTIR) and Thermo Gravimetric Analysis (TGA). Both analytical techniques indicated that a small amount of water was associated with the product.

While not wishing to be bound by theory, Applicants believe that the barrier properties of the films of this invention can be optimized by ensuring that the calcium phthalate is well dispersed in the HDPE. Thus, the use of small particle size (e.g. less than 50 microns, especially less than 10 microns) is recommended.

The amount of calcium phthalate used is from 500 to 5000 parts per million by weight (ppm) based on the weight of the HDPE.

### Zinc Stearate/Calcium Stearate

The present invention also requires the use of a metal stearate selected from the group consisting of zinc stearate and calcium stearate. Both of these metal stearates are well known and are commonly used as additives for polyethylene and polypropylene.

Data provided in the examples show that barrier performance (especially WVTR) is enhanced by the combination of calcium phthalate and zinc stearate. The amount of metal stearate used is from 500 to 5000 ppm.

The metal stearate and calcium phthalate may be premixed (to form a so called “pre-blend”) prior to adding to the HDPE.

The use of a “master batch” (which is prepared by melt mixing the calcium phthalate, metal stearate and a small amount of HDPE) is especially preferred. A typical master batch would contain about 80-98% by weight of HDPE, with the remaining 20-2% being the calcium phthalate and metal stearate. The master batch is then added to the remaining HDPE during the final extrusion process in order to provide the desired amount of calcium phthalate and zinc stearate in the final product.

### Other Additives

The HDPE may also contain other conventional additives, especially (1) primary antioxidants (such as hindered phenols, including vitamin E); (2) secondary antioxidants (especially phosphites and phosphonites); and (3) process aids (especially fluoroelastomer and/or polyethylene glycol bound process aid). In addition, the use of particulate antiblocking agents (such as silica) is contemplated. The use of silica may help to disperse the calcium phthalate.

### Film Extrusion Process

Blown Film Process

The extrusion-blown film process is a well known process for the preparation of plastic film. The process employs an extruder which heats, melts and conveys the molten plastic and forces it through an annular die. Typical extrusion temperatures are from 330 to 500° F., especially 350 to 460° F.

The polyethylene film is drawn from the die and formed into a tube shape and eventually passed through a pair of draw or nip rollers. Internal compressed air is then introduced from the mandrel causing the tube to increase in diameter forming a “bubble” of the desired size. Thus, the blown film is stretched in two directions, namely in the axial direction (by the use of forced air which “blows out” the diameter of the bubble) and in the lengthwise direction of the bubble (by the action of a winding element which pulls the bubble through the machinery). External air is also introduced around the bubble circumference to cool the melt as it exits the die. Film width is varied by introducing more or less internal air into the bubble thus increasing or decreasing the bubble size. Film thickness is controlled primarily by increasing or decreasing the speed of the draw roll or nip roll to control the draw-down rate.

The bubble is then collapsed into two doubled layers of film immediately after passing through the draw or nip rolls. The cooled film can then be processed further by cutting or sealing to produce a variety of consumer products. While not wishing to be bound by theory, it is generally believed by those skilled in the art of manufacturing blown films that the physical properties of the finished films are influenced by both the molecular structure of the polyethylene and by the processing conditions. For example, the processing conditions are thought to influence the degree of molecular orientation (in both the machine direction and the axial or cross direction).

A balance of “machine direction” (“MD”) and “transverse direction” (“TD”—which is perpendicular to MD) molecular orientation is generally considered most desirable for key properties associated with the invention (for example, Dart Impact strength, Machine Direction and Transverse Direction tear properties).

Thus, it is recognized that these stretching forces on the “bubble” can affect the physical properties of the finished film. In particular, it is known that the “blow up ratio” (i.e. the ratio of the diameter of the blown bubble to the diameter of the annular die) can have a significant effect upon the dart impact strength and tear strength of the finished film.

The above description relates to the preparation of monolayer films. Multilayer films may be prepared by 1) a “co-extrusion” process that allows more than one stream of molten polymer to be introduced to an annular die resulting in a multi-layered film membrane or 2) a lamination process in which film layers are laminated together. The films of this invention are preferably prepared using the above described blown film process.

An alternative process is the so-called cast film process, wherein the polyethylene is melted in an extruder, then forced through a linear slit die, thereby “casting” a thin flat film. The extrusion temperature for cast film is typically somewhat hotter than that used in the blown film process (with typically operating temperatures of from 450 to 550° F.). In general, cast film is cooled (quenched) more rapidly than blown film.

Further details are provided in the following examples.

### EXAMPLES

### Example 1

HDPE barrier film compositions were prepared on a blown film line manufactured by Macro Engineering Company of Mississauga, Ontario, Canada.

The blown film bubble is air cooled. Typical blow up ratio (BUR) for barrier films prepared on this line are from 1.5/1 to 4/1.

The films of this example were prepared using a film thickness aiming point of 1.5 mils.

Water Vapor Transmission Rate (“WVTR”, expressed as grams of water vapor transmitted per 100 square inches of film per day at a specified film thickness (mils), or g/100 in²/day) was measured in accordance with ASTM F1249-90 with a MOCON permatron developed by Modern Controls Inc. at conditions of 100° F. (37.8° C.) and 100% relative humidity.

An HDPE blend was used in all experiments. This HDPE blend was prepared in a dual reactor solution polymerization process in accordance with the disclosure of published U.S. patent application 20060047078 (Swabey et al.). The HDPE blend had a melt index, I₂, of 1.2 grams/10 minutes, a density of 0.967 g/cc and a molecular weight distribution, Mw/Mn, of 8.9. The HDPE blend had two distinct fractions which varied according to molecular weight. The low molecular weight fraction (or component a)) was about 55 weight % of the total composition and had a melt index, I₂, which was estimated to be greater than 5000 grams/10 minutes. The high molecular weight fraction was about 45 weight % of the total composition and had a melt index which was estimated to be less than 0.1 grams/10 minutes.

As noted above, melt index (I₂) is generally inversely proportional to molecular weight for polyethylene resins. This was confirmed for homopolymer HDPE resins having a narrow molecular weight distribution (of less than 3) by preparing a plot of log (I₂) versus log (weight average molecular weight, Mw). In order to prepare this plot, the melt index (I₂) and weight average molecular Mw) of more than 15 different homopolymer HDPE resins was measured. These homopolymer HDPE resins had a narrow molecular weight distribution (less than 3) but had different Mw—ranging from about 30,000 to 150,000. (As will be appreciated by those skilled in the art, it is difficult to obtain reproducible I₂ values for polyethylene resins having a molecular weight which is outside of this range).

A log/log plot of these I₂ and Mw values was used to calculate the following relation between I₂ and Mw for such homopolymer HDPE resins:

I₂=(1.774×10⁻¹⁹)×(Mw^{-3.86}).

Extrapolation (based on the above relation) was used to estimate the I₂ values of component a) and component b) of the HDPE blend. That is, the molecular weight of component a) and component b) was measured and the Mw values were used to estimate the I₂ values. It will be appreciated by those skilled in the art that it can be difficult to physically blend these HDPE blend components (due to the very different viscosities of these HDPE blend components). Accordingly, solution blending or an in-situ blending (i.e. prepared by a polymerization process) are preferred methods to prepare such HDPE compositions.

A first comparative film was prepared from the above described HDPE blend. The HDPE blend did contain conventional antioxidants (a hindered phenol and a hindered phosphite) but did not contain calcium phthalate or zinc stearate. A film having a thickness of 1.5 mils was prepared (on the “Macro” line); tested (on the “MOCON” instrument) and observed to have a MVTR of 0.17 g/100 in²/day.

Two additional comparative films—comparative 2 and 3—were prepared. Comparative film 2 contained 1000 ppm calcium phthalate; comparative film 3 contained 2000 ppm calcium phthalate. The MVTR for film 2 was 0.15 g/100 in²/day (at a thickness of 1.6 mils) and the MVTR for film 3 was 0.14 g/100 in²/day (at a thickness of 1.5 mils).

Inventive film 1 contained 1000 ppm calcium phthalate and 1000 ppm of zinc stearate. The MVTR of this film was measured at 0.12 g/100 in²/day at a film thickness of 1.6 mils.

A second inventive film was prepared with 2000 ppm of calcium phthalate and 2000 ppm of zinc stearate. This film had an MVTR of 0.09 g/100 in²/day.

Thus, excellent MVTR is provided by the combined use of calcium phthalate and zinc stearate in accordance with the present invention.

### INDUSTRIAL APPLICABILITY

A blend of ethylene polymer, calcium phthalate and zinc stearate is suitable for the manufacture of barrier packaging. The blend is especially suitable for the preparation of extruded film having a low Water Vapour Transmission rate, such as film used to package crackers or bakery products.

1. A polyethylene composition comprising:
a) high density polyethylene;
b) from about 500 to about 5000 parts per million by weight of calcium phthalate; and
c) from about 500 to about 5000 parts per million by weight of at least one metal stearate selected from the group consisting of zinc stearate and calcium stearate.

2. The composition of claim 1 wherein said high density polyethylene has
a) a melt index, I₂, of from about 0.2 to about 200 grams per 10 minutes; and
b) a density of from about 0.940 g/cc to about 0.970 g/cc.

3. The composition of claim 2 wherein said high density polyethylene has a density of from about 0.960 to about 0.968 g/cc.

4. A film prepared from the composition of claim 3.

5. A molded part prepared from the composition of claim 2.

6. A process to prepare a barrier film, said process comprising the film extrusion of a composition comprising
(a) a high density polyethylene having a melt index, I₂, of from about 0.2 to about 20 grams per 10 minutes and a density of from about 0.960 to about 0.968 g/cc;
(b) from about 500 to about 5000 parts per million by weight calcium phthalate; and
(c) from about 500 to about 5000 parts per million by weight of at least one metal stearate from the group consisting of zinc stearate and calcium stearate.

7. A process to improve the barrier performance of high density polyethylene film, said process comprising the film extrusion of a composition comprising
a) a high density polyethylene having a melt index, I₂, of from about 0.2 to about 20 grams per 10 minutes and a density of from about 0.960 to about 0.968 g/cc;
b) from about 500 to about 5000 parts per million by weight of calcium phthalate; and
c) from about 500 to about 5000 parts per million by weight of at least one metal stearate from the group consisting of zinc stearate and calcium stearate;
wherein said film has at least a 15% improvement, compared with a film prepared in the absence of said calcium phthalate, in the water vapor barrier property.
